(19) United States
(12) Patent Application Publication
(10) Pub. No.: US 2024/0036838 A1
(43) Pub. Date: Feb. 1, 2024

(54) MANAGEMENT OF RESOURCE SHARING AMONG DEVICES OPERATING ON DIFFERENT PLATFORMS

(71) Applicant: INTERNATIONAL BUSINESS MACHINES CORPORATION, ARMONK, NY (US)

(72) Inventors: Jun Su, Beijing (CN); Peng Hui Jiang, Beijing (CN); Gang Tang, Nanjing (CN); Guang Han Sui, Beijing (CN); ZI YUN KANG, Handan (CN)

(21) Appl. No.: 17/816,031

(22) Filed: Jul. 29, 2022

(51) Int. Cl. G06F 8/41; H04L 9/40; G06F 9/455

(52) U.S. Cl. CPC G06F 8/433; H04L 63/0281; G06F 9/45558; G06F 2009/45595; G06F 2009/4557

(57) ABSTRACT

This disclosure provides a method, a computing system and a computer program product for managing resource sharing among devices with different platforms. The method comprises obtaining connection information for connecting to a requesting device by decoding authentication information, wherein the authentication information is created based at least on an identifier of the requesting device. The method further comprises sending a request including the connection information to a request proxy, wherein the request is redirected by the request proxy to a plurality of devices having more than one platform. The method further comprises receiving a response to the request, wherein the response is obtained by combining responses received by the request proxy from the plurality of devices.

### BACKGROUND

The present disclosure relates to devices operating on different platforms, and more specifically, to management of resource sharing among devices that are running or part of different platforms.

Resource sharing among devices running different platforms has been increasingly important, since resource sharing is transforming the way data is being handled, processed and delivered between millions of devices around the world. Examples of resource sharing among devices operating as part of different platforms may include edge computing, resource sharing among hybrid servers (e.g., servers with different infrastructures, operating systems or from different vendors), or the like. For example, within the environment of edge computing, there may be a large number of edge devices utilization different platforms during operation of the edge device (e.g., having different infrastructures, operating systems or applications), but a single edge device generally may not be able to complete an edge computing task due to its limited computing resources.

### SUMMARY

According to one embodiment of the present disclosure, a computer-implemented method is provided. The method comprises obtaining connection information for connecting to a requesting device by decoding authentication information, wherein the authentication information is created based at least on an identifier of the requesting device. The method further comprises sending a request including the connection information to a request proxy, wherein the request is redirected by the request proxy to a plurality of devices having more than one platform. The method further comprises receiving a response to the request, wherein the response is obtained by combining responses received by the request proxy from the plurality of devices.

According to another embodiment of the present disclosure, a computing system is provided. The computing system comprises a processor and a computer-readable memory unit coupled to the processor. The memory unit comprising instructions that, when executed by the processor, perform actions of obtaining connection information for connecting to a requesting device by decoding authentication information, wherein the authentication information is created based at least on an identifier of the requesting device. The memory unit further comprising instructions that, when executed by the processor, perform actions of sending a request including the connection information to a request proxy, wherein the request is redirected by the request proxy to a plurality of devices having more than one platform. The memory unit further comprising instructions that, when executed by the processor, perform actions of receiving a response to the request, wherein the response is obtained by combining responses received by the request proxy from the plurality of devices.

According to a further embodiment of the present disclosure, a computer program product is provided. The computer program product comprises a computer readable storage medium having program instructions embodied therewith. The program instructions are executable by a computer to cause the computer to perform actions of obtaining connection information for connecting to a requesting device by decoding authentication information, wherein the authentication information is created based at least on an identifier of the requesting device. The program instructions are executable by a computer to further cause the computer to perform actions of sending a request including the connection information to a request proxy, wherein the request is redirected by the request proxy to a plurality of devices having more than one platform. The program instructions are executable by a computer to further cause the computer to perform actions of receiving a response to the request, wherein the response is obtained by combining responses received by the request proxy from the plurality of devices.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference numbers generally refer to the same components in the embodiments of the present disclosure.

FIG. 1 depicts a cloud computing node according to an embodiment of the present disclosure.

FIG. 2 depicts a cloud computing environment according to an embodiment of the present disclosure.

FIG. 3 depicts abstraction model layers of a cloud computing environment according to an embodiment of the present disclosure.

FIG. 4 depicts an exemplary embodiment of a system configured to manage resource sharing among devices operating using different platforms according to the present disclosure.

FIG. 5 depicts a diagram of an exemplary embodiment illustrating how to generate a shared dependency map in accordance with the present disclosure.

FIG. 6 depicts an exemplary embodiment diagramming an architecture for cross-platform applications based on the shared dependency map in accordance with the present disclosure.

FIG. 7 depicts a flow chart describing an exemplary embodiment of a method for managing resource sharing among devices operating using different platforms in accordance with the present disclosure.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

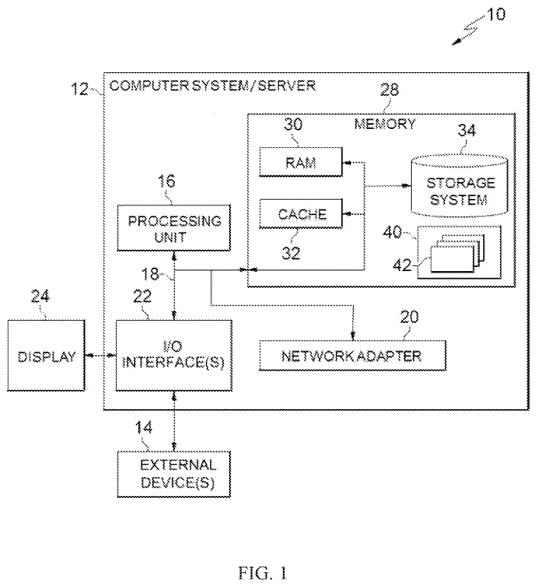

Referring now to FIG. 1, a schematic of an example of a cloud computing node 10 is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. Cloud computing node 10 may comprise a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 operating as part of cloud computing node 10 is shown in the form of a general-purpose computing device. The components of computer system/server 12 may include, but are not limited to, one or more processors or processing units 16, memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 can include a variety of computer system readable media. Such media may be any available media that is accessible by computer system/server 12, and it includes both volatile and non-volatile media, removable and non-removable media. System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that can be configured to carry out the functions of embodiments of the present disclosure.

Program/utility 40, having a set of at least one program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally may carry out the functions and/or methodologies of embodiments of the present disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interface(s) 22. Computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to microcode, device drivers, redundant processing units, external disk drive arrays, RAID systems, tape drives, and data archival storage systems, etc.

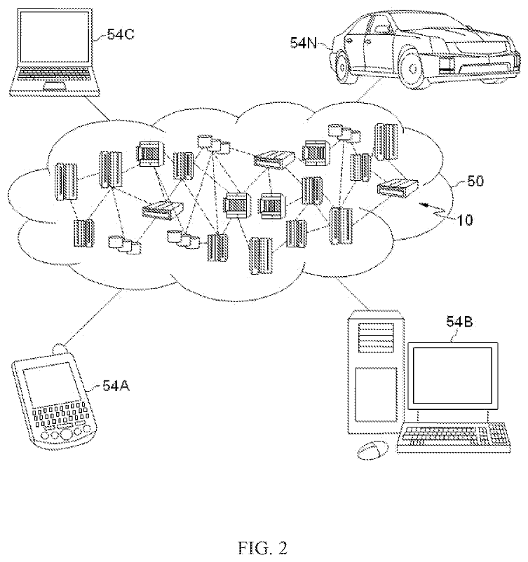

Referring now to FIG. 2, a cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another and may be grouped (not shown) physically or virtually, in one or more networks, such as Private, Community, Public, or Hybrid clouds as described hereinabove, or a combination thereof. Cloud computing environment 50 can offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

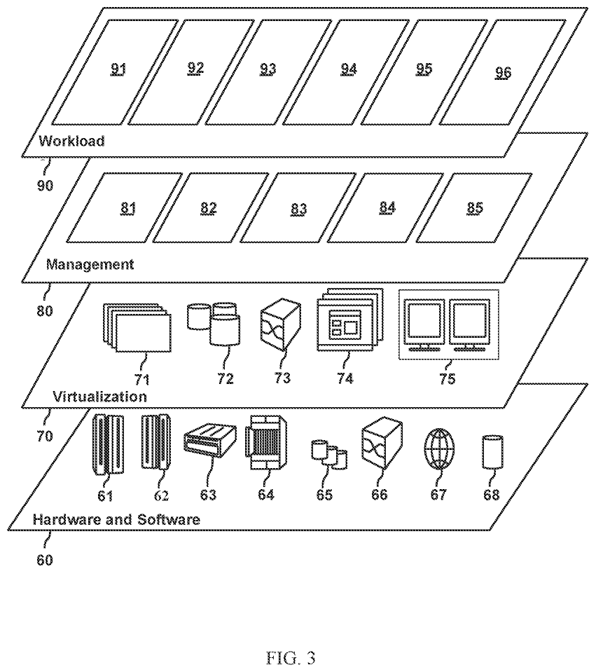

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and resource sharing management 96.

Due to the variety of platforms utilized by different devices, it can be difficult to share resources between the devices. There is a need to manage resource sharing among devices operating using different platforms to enable applications from the devices to work together. Therefore, there is a need for a solution to effectively and efficiently managing resource sharing among devices operating on different platforms. To address the need, disclosed herein are embodiments of a method, system and computer program product for managing resource sharing among those devices operating on different platforms.

Note that, some different devices may share at least one common dependent application component, in spite of the different platforms being used by the devices. A dependent application component may include any component that an application is dependent on, such as, a module, an Application Programming Interface (API) or the like. For example, a car-sharing application XX is running on device A, and a different car-sharing application YY is running on device B. Although the car-sharing applications XX and YY do not work together, the two different car-sharing applications may both have a same map component. Then, it may be possible for devices A and B to share computing resources by using the same map component. By leveraging shared dependent application components, devices operating using different platforms can share resources (e.g., computing resources) and work together. In addition, it is desirable to design an effective mechanism for dispatching requests and transmitting responses among the devices using different platforms.

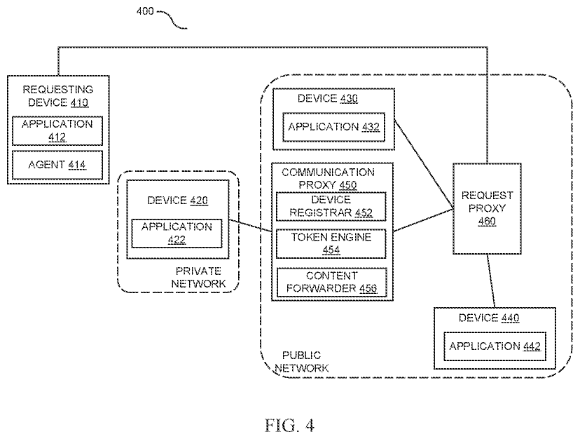

With reference now to FIG. 4, FIG. 4 shows an exemplary system 400 configured to manage resource sharing among devices using different platforms according to an embodiment of the present disclosure. As shown, the system 400 includes devices 410, 420, 430 and 440, a request proxy 460 and a communication proxy 450. The devices 410, 420, 430 and 440 may have more than one platform (e.g., two, or three, or four different platforms). For example, device 410 may be running Windows® OS (Operating System), device 420 may be running MAC® OS, device 430 may be running Linux® OS, and device 440 may be running Android® OS, etc. It should be noted that four devices are illustrated here by way of example, and an actual system may include any appropriate number of devices.

In FIG. 4, device 410 is shown as the current requesting device as an example. It should be appreciated that during the resource sharing process, any of the devices 410, 420, 430, 440 can function as the requesting device 410. That is to say, any of the devices 410-440 can send a request, and at least some of the other devices can respond to the request, for example, by sharing computing resources to process the request. According to some embodiments of the disclosure, before sending a request, the requesting device 410 may first obtain connection information allowing a connection to be made with the requesting device 410 by decoding authentication information, wherein the authentication information is created based at least on an identifier of the requesting device 410. For example, the authentication information may include a token, a certificate, or the like, and the authentication information may contain connection information encoded using any appropriate algorithm (such as base64). According to some embodiments of the disclosure, the authentication information may be generated by a centralized server (not shown) and sent to the requesting device 410 through a token engine 454 of a communication proxy 450. An example of the token may be “eyJjbGllbnRJRCI6Inh4eHh4eHh4eHgiLCJpcCI6Inh4eC54eHgueHh4Lnh4eCIsInBvcnQi004e Hh4IiwiaXNQcm12YXR1IjpOcnV1LCJhbCI6IkhTMjU2IiwiYWxnIjoiSFMyNTYifQ.eyJzdWIi0 iIxMjMONTY30DkwIiwibmFtZSI61kpvaG4gRG91IiwiaWFOIjoxNTE2MjM5MDIyfQ.1h5Hkc VwPxKVxR2i8o4dsU7Dxwws3C-DNg5m1KfbVLY”, and the decoded connection information may include: ““clientID”: “ABC”, “ip”: “123.123.123.123”, “port”: “1234”, “isPrivate”: true, “apptype”: “web”, “resource”: “a dual core CPU” . . . ”. The connection information may indicate that the requesting device 410 has a client ID “ABC”, its IP (Internet Protocol) address is “123.123.123.123”, the port for communication is “1234”, the requesting device 410 is in a private network, the application initiating the request is a web-based application, and the computing resource that the requesting device 410 can share include a dual core CPU. It should be noted that the connection information may include any other information for connecting to the requesting device 410. For example, if the requesting device 410 is in a private network, the connection information may also include information about the content forwarder 456, such as the Globally Unique Identifier (GUID) or IP address of the content forwarder 456.

Embodiments of the requesting device 410 may send a request including the connection information to the request proxy 460. The request may be redirected by the request proxy 460 to devices 420 and 430. According to some embodiments of the disclosure, the request may be initiated by an application 412 of the requesting device 410. According to some embodiments of the disclosure, the requesting device 410 may start an agent 414. The agent 414 may perform operations associated with the resource sharing process. Similarly, devices 420, 430 and 440 may also start an agent (not shown). By performing the communication using the agents, the security of the resource sharing process may be further enhanced. For the device 430 that is connected to a public network (e.g., in an airport, or in an Internet cafe), the request may be redirected by the request proxy 460 directly to the device 430; while for device 420, which is located in a private network (e.g., in a home network, or in a company network), the request may be redirected by the request proxy 460 to the communication proxy 450 in the public network, and a content forwarder 456 of the communication proxy 450 may send the request to the device 420. Similarly, if the requesting device 410 is in a private network, the request may be sent to the request proxy 460 through the content forwarder 456, rather than directly sent to the request proxy 460. To communicate with devices in the public network, devices in a private network (e.g., device 420) may first register itself to a device registrar 452 of the communication proxy 450. It should be noted that the communication proxy 450 and the request proxy 460 may be implemented on any of the devices performing resource sharing functions as part of the public network (such as device 430) or may be implemented on a separate computing system or node of the public network.

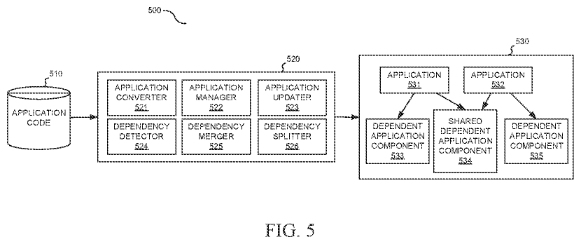

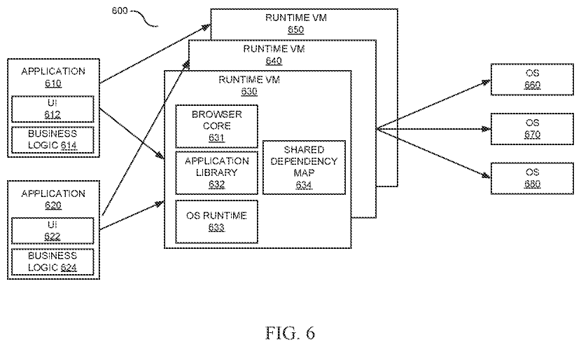

According to some embodiments of the disclosure, the request proxy 460 may select the devices 420 and 430 (but not select device 440) to redirect the request based at least on a shared dependency map, and the shared dependency map may indicate that the devices 420 and 430 share at least one dependent application component with the requesting device 410. According to some embodiments of the disclosure, the shared dependency map may also indicate that the device 440 does not share any dependent components of application 442 with the requesting device 410. The shared dependency map may be used to represent the dependency between applications 412, 422, 432, 442 and dependent application components thereof, and may also show which dependent application components are shared by the applications 412, 422, 432, 442 of devices 410, 420, 430, 440, which will be described in more detail below with respect to FIGS. 5 and 6. According to some embodiments of the disclosure, the shared dependency map may be generated by analyzing dependent application components of the devices 420-440 and the requesting device 410. According to some embodiments of the disclosure, the devices 410-440 may each maintain at least one shared dependency map, and the request proxy 460 may obtain information about the shared dependency maps from devices 410-440, and determine whether the application 412 of the requesting device 410 imitating the request shares a dependent application component (e.g., program module) with the application 422 of the device 420, the application 432 of the device 430 and/or with application 442 of device 440. Thus, the devices 410-440 may work together using the shared dependent application component, and thereby the request from the device 410 may be redirected to devices 420-440 to be processed.

According to some embodiments of the disclosure, the selection of the devices 410-440 to redirect the request to may be further based on the connection information received from the requesting device 410. For example, if the connection information indicates that the requesting device 410 is in the public network, the request proxy 460 may give priority to the devices that are also in the public network when selecting the devices to redirect the request to. It should be noted that the selection of the devices to redirect the request to may be further based on other factors, such as traffic, or workload, so as to improve efficiency and load balance of the system 400. According to some embodiments of the disclosure, if the request is a registration request, it may be redirected to all other devices 410-440.

The request proxy 460 may receive responses from devices 420 and 430, and generate a response to the request by combining the responses from devices 420 and 430. The requesting device 410 may receive the response to the request from the request proxy 460. According to some embodiments of the disclosure, the request may be a registration request for performing resource sharing with the other devices (e.g., joining the resource sharing group). The request proxy 460 may send the registration request to devices 420-440 and a response from each of the devices 420-440 may include a message indicating whether the respective device agrees with the registration request. The request proxy 460 may collect responses from devices 420-440 and determine whether the responses indicate that the request is approved or not. For example, the request proxy 460 may determine that the request is approved if more than a threshold percentage (e.g., 50%) of the devices 420-440 agree with the request. As another example, the request proxy 460 may determine that the request is not approved if any of the devices 420-440 disagrees with the request. The request proxy 460 may send a response to the registration request to the requesting device 410, which may include a decision on whether the registration request is approved. According to some embodiments of the disclosure, the request may be a computation request corresponding to a computation task (e.g., analyzing the traffic conditions of a region). The request proxy 460 may send the computation request to devices 420-440 based at least on a shared dependency map, as discussed above. Each of the devices 420-440 may perform a part of the computation task and return a partial result (e.g., the traffic conditions of an area in the region) to the request proxy 460, which may form at least a part of the computation result. The request proxy 460 may combine (e.g., add, maximize, average, or the like) the partial results received from devices 420-440 and generate a computation result, and send the computation result to the requesting device 410 as a response to the computation request.

FIG. 5 is a diagram of an exemplary embodiment 500 showing how to generate a shared dependency map according to present disclosure. In order to enable resource sharing among devices with different platforms, applications should be adapted to run on the different platforms and the shared dependency map of the applications may be generated. As shown in FIG. 5, application code 510 may be provided to a build server 520 (e.g., of an application vendor). In the example of FIG. 5, the application code 510 includes program code for applications 531 and 532. It should be noted that the application code 510 may include program code for any appropriate number of applications. The build server 520 may include an application converter 521, an application manager 522, an application updater 523, a dependency detector 524, a dependency merger 525 and a dependency splitter 526.

The dependency detector 524 may detect the dependent application components of applications 531 and 532, which can be accomplished by using existing methods for constructing a dependency tree of an application, such as ldd command in Linux. The dependency merger 525 may be configured to merge the dependent application components of applications 531 and 532, and the dependency splitter 526 may be configured to split the dependent application components of applications 531 and 532. For example, if the applications 531 and 532 have the same files: “file1” and “file2”, the dependency merger 525 may try to merge “file1” and “file2”. If “file1” and “file2” can constitute a library “lib1”, the dependency merger 525 may determine that the applications 531 and 532 share the same library “lib1”. As another example, if the application 531 depends on a library “lib1” and the application 532 depends on a different library “lib2”, the dependency splitter 526 may split the libraries “lib1” and “lib2” separately to check whether they share a same file. Therefore, by splitting and/or merging the dependent application components of the applications, shared dependent application components with an appropriate granularity may be determined, and thereby a shared dependency map 530 may be generated.

The application converter 521, the application manager 522, and the application updater 523 may be used to release a cross-platform application. The application converter 521 may convert an application running on a first platform (e.g., Linux OS) to an applicable application running on a second platform (e.g., Windows OS). The application manager 522 may manage the libraries of the applications. The application updater 523 may update the packages of the applications for different releases on the different platforms. According to some embodiments of the disclosure, the shared dependency map 530 may be packaged along with a cross-platform application to facilitate subsequent resource sharing based on the shared dependency map 530.

It should be noted that the shared dependency map 530 is only a simplified example, and the shared dependency map 530 may include a larger number of dependent application components and more than one layer. The shared dependency map 530 may represent a hierarchy of the dependent application components 533, 534, 535 of applications 531 and 532 and may also show which dependent application component(s) 531-535 are shared by applications 531 and 532. As shown in the shared dependency map 530, the application 531 has two dependent application components 533 and 534, and the application 532 has two dependent application components 534 and 535. The dependent application component 534 is a shared dependent application component of both applications 531 and 532. For example, the two applications 531 and 532 may be two different car-sharing applications, and the shared dependent application component 534 may be a map component. The shared dependent application component 534 of the applications 531 and 532 may be run on a same runtime Virtual Machine (VM) using isolation and scope techniques (such as those used in the SpiderMonkey engine or the Chrome V8 engine), thereby reducing running cost and overhead.

FIG. 6 describes an exemplary architecture 600 embodiment of cross-platform applications based on a shared dependency map according to an embodiment of the present disclosure. The cross-platform applications 610 and 620 may be built, for example, by the build server 520 shown in FIG. 5. Application 610 may include a User Interface (UI) 612 and a business logic 614, while application 620 may include a UI 622 and a business logic 624. The UIs 612 and 622 and the business logics 614 and 624 may be created with any appropriate programming language (such as HTML, CSS or JavaScript) and using any appropriate development platform (such as React, VUE, or Angular).

The applications 610 and 620 are shown as running on three runtime VMs 630, 640 and 650 as an example. It should be noted that a plurality of runtime VMs can be run on a single device and the number of runtime VMs running on a device can be dynamically scaled according to actual requirements. The runtime VM 630 may include a browser core 631, an application library 632, an OS runtime 633 and a shared dependency map 634. Note that, the applications 610 and 620 are shown as web-based applications as an example. The browser core 631 can be a cross-platform browser core (such as Chrome) and can render the UIs 612 and 622. The application library 632 may function as a middleware and support dynamic downloading of packages of the applications 610 and 620 from a remote repository. The OS runtime 633 may use native OS API to provide network, filesystem, process/thread support and may be cross-platform, such as libuv. The shared dependency map 634 may be generated, for example, by the build server 520 shown in FIG. 5. By including the shared dependency map 634 in the runtime VM 630, the relationship between the runtime VMs 630, 640 and 650 may be tracked. The runtime VMs 640 and 650 may have similar structures (which are not repeated herein).

Embodiments of application 610 may be the application 531 (shown in FIG. 5) while the application 620 may be application 532. The applications 610 and 620 have a shared dependent application component 534, which may be run on within runtime VM 630. The dependent application component 533 may be run on the runtime VM 650 and the dependent application component 535 may be run on the runtime VM 640. The runtime VMs 630, 640 and 650 may serve as client-side micro services and they can share resources and communicate with each other, as needed, thereby reducing running cost. The runtime VMs 630, 640 and 650 may be managed independently using applications 610 and 620. A single runtime VM 630, 640, 650 may have multiple different versions due to system upgrades. For example, the shared dependency map 634 may be updated according to a system upgrade. Since the browser core 631, the application library 632 and the OS runtime 633 are all cross-platform, the applications 610 and 620 can be run on different platforms, such as OS 660, OS 670 and OS 680.

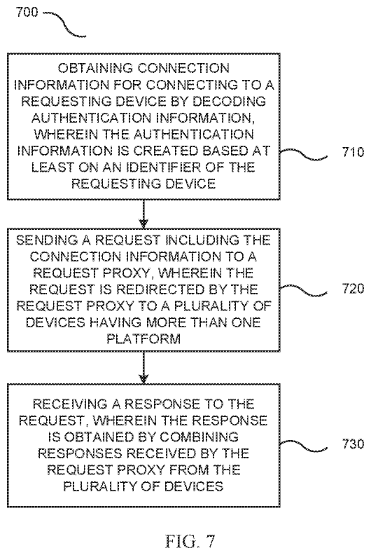

FIG. 7 comprises a flow chart showing an exemplary method 700 for managing resource sharing among devices operating using different platforms, according to an embodiment of the present disclosure. It should be noted that the processing of the method 700 according to embodiments of this disclosure could be implemented by computer system/server 12 of FIG. 1. At step 710, the method 700 may include obtaining connection information for connecting to a requesting device (such as the requesting device 410 in FIG. 4). Obtaining connection information may be performed by decoding authentication information, wherein the authentication information is created based at least on an identifier of the requesting device 410.

At step 720, the method 700 may include sending a request, including the connection information, to a request proxy (such as the request proxy 460 in FIG. 4), wherein the request is redirected by the request proxy 460 to a plurality of devices having more than one platform (such as devices 420 and 430 in FIG. 4). According to some embodiments of the disclosure, the plurality of devices may be selected based at least on a shared dependency map (such as the shared dependency map 530 in FIG. 5 or the shared dependency map 634 in FIG. 6). The shared dependency map 530 may indicate whether the plurality of devices share at least one dependent application component with the requesting device 410. According to some embodiments of the disclosure, the shared dependency map 530 may be generated by analyzing dependent application components of the plurality of devices and the requesting device 410. According to some embodiments of the disclosure, at least one shared dependent application component of two or more applications of the requesting device is run on a same runtime virtual machine (such as the runtime VM 630 in FIG. 6).

At step 730, the method 700 may include receiving a response to the request, wherein the response is obtained by combining responses received by the request proxy 460 from the plurality of devices. According to some embodiments of the disclosure, the request may be a registration request. Responses to the request may include a decision on whether the registration request is approved, and a response from each of the plurality of devices may include a message indicating whether each of the devices receiving the request agree with the registration request. According to some embodiments of the disclosure, the request may be a computation request, the response to the request may include a computation result, and a response from each of the plurality of devices may include at least a part of the computation result. According to some embodiments of the disclosure, the requesting device 410 may be in a private network. The request may be sent to the request proxy through a content forwarder in a public network (such as the content forwarder 456 in FIG. 4), and the response to the request may be received from the content forwarder 456.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
obtaining, by one or more processing units, connection information for connecting to a requesting device by decoding authentication information, wherein the authentication information is created based at least on an identifier of the requesting device;
sending, by the one or more processing units, a request including the connection information to a request proxy, wherein the request is redirected by the request proxy to a plurality of devices having more than one platform; and
combining, by the one or more processing units, responses received by the request proxy from the plurality of devices.

2. The computer-implemented method of claim 1, wherein the request is a registration request, the responses to the request includes a decision whether the registration request is approved, and a response from each of the plurality of devices includes a message indicating whether each of the plurality of device agrees with the registration request.

3. The computer-implemented method of claim 1, wherein the request is a computation request, the response to the request includes a computation result, and a response from each of the plurality of devices includes at least a part of the computation result.

4. The computer-implemented method of claim 1, wherein the plurality of devices are selected based at least on a shared dependency map, and the shared dependency map indicates that the plurality of devices share at least one dependent application component with the requesting device.

5. The computer-implemented method of claim 4, wherein the shared dependency map is generated by analyzing dependent application components of the plurality of devices and the requesting device.

6. The computer-implemented method of claim 1, wherein:
the requesting device is in a private network;
the request is sent to the request proxy through a content forwarder in a public network; and
the response to the request is received from the content forwarder.

7. The computer-implemented method of claim 1, wherein at least one shared dependent application component of two or more applications of the requesting device is run on a same runtime virtual machine.

8. A computing system, comprising:
a processor;
a computer-readable memory unit coupled to the processor, the memory unit comprising instructions that, when executed by the processor, perform actions of:
obtaining, the processor, connection information for connecting to a requesting device by decoding authentication information, wherein the authentication information is created based at least on an identifier of the requesting device;
sending, by the processor, a request including the connection information to a request proxy, wherein the request is redirected by the request proxy to a plurality of devices having more than one platform; and
combining, by the processor, responses received by the request proxy from the plurality of devices.

9. The computing system of claim 8, wherein the request is a registration request, the responses to the request includes a decision whether the registration request is approved, and a response from each of the plurality of devices includes a message indicating whether each of the plurality of device agrees with the registration request.

10. The computing system of claim 8, wherein the request is a computation request, the response to the request includes a computation result, and a response from each of the plurality of devices includes at least a part of the computation result.

11. The computing system of claim 8, wherein the plurality of devices are selected based at least on a shared dependency map, and the shared dependency map indicates that the plurality of devices share at least one dependent application component with the requesting device.

12. The computing system of claim 11, wherein the shared dependency map is generated by analyzing dependent application components of the plurality of devices and the requesting device.

13. The computing system of claim 8, wherein:
the requesting device is in a private network;
the request is sent to the request proxy through a content forwarder in a public network; and
the response to the request is received from the content forwarder.

14. The computing system of claim 8, wherein at least one shared dependent application component of two or more applications of the requesting device is run on a same runtime virtual machine.

15. A computer program product, comprising a computer readable storage medium having program instructions embodied therewith, the program instructions executable by a processor to cause the processor to perform actions of:
obtaining connection information for connecting to a requesting device by decoding authentication information, wherein the authentication information is created based at least on an identifier of the requesting device;
sending a request including the connection information to a request proxy, wherein the request is redirected by the request proxy to a plurality of devices having more than one platform; and
combining responses received by the request proxy from the plurality of devices.

16. The computer program product of claim 15, wherein the request is a registration request, the responses to the request includes a decision whether the registration request is approved, and a response from each of the plurality of devices includes a message indicating whether each of the plurality of device agrees with the registration request.

17. The computer program product of claim 15, wherein the request is a computation request, the response to the request includes a computation result, and a response from each of the plurality of devices includes at least a part of the computation result.

18. The computer program product of claim 15, wherein the plurality of devices are selected based at least on a shared dependency map, and the shared dependency map indicates that the plurality of devices share at least one dependent application component with the requesting device.

19. The computer program product of claim 18, wherein the shared dependency map is generated by analyzing dependent application components of the plurality of devices and the requesting device.

20. The computer program product of claim 15, wherein at least one shared dependent application component of two or more applications of the requesting device is run on a same runtime virtual machine.
